(19) United States
(12) Patent Application Publication
(10) Pub. No.: US 2003/0076012 A1
(43) Pub. Date: Apr. 24, 2003

(54) Device for protection against harmful agents

(75) Inventor: Charles Laubie, Paris (FR)

Correspondence Address: YOUNG & THOMPSON, 745 SOUTH 23RD STREET 2ND FLOOR, ARLINGTON, VA, 22202

(73) Assignee: SEMA

(21) Appl. No.: 09/984,048

(22) Filed: Oct. 26, 2001

(30) Foreign Application Priority Data
Oct. 19, 2001 (FR) 0013528

(51) Int. Cl. A61G 11/00

(52) U.S. Cl. 312/1

(57) ABSTRACT

Device for protection against harmful agents, comprising a part 1 forming a chamber, an entrance part 5, 6 to allow an object to be placed in the chamber, and a manipulating part 14 for manipulating, from the outside, an object situated in the chamber, and a means of closing the entrance part.

The field of the invention is the protecting of people, especially workers, against harmful agents contained in objects such as letters, boxes, envelopes, etc.

When an object is suspected of containing a harmful agent, poison, chemical, bacteriological or biological contaminant in an organization receiving or handling mail or the like, such as an office, a postal service or private courier business, or a business receiving mail, it is desirable to put in place safety measures designed to protect staff while allowing normal activities to continue, bearing in mind the generally high number of false alarms.

The invention provides a device for isolating a suspect object and opening it in a safe environment.

The device, in one aspect of the invention, is designed for protection against harmful agents, and comprises a part forming a chamber, an entrance part to allow an object to be placed in the chamber, a manipulating part for manipulating, from the outside, an object situated inside the chamber, the said parts being made of impermeable walls, and a means of closing the entrance part.

The suspect object can be inserted through the entrance and placed inside the chamber. The entrance is then closed and an operator can take the suspect object and open it inside the chamber, optionally with the aid of a tool inserted in the chamber before it was closed up. If suspect products are found, the device containing the opened suspect object can be taken safely to a laboratory for analysis or to an incinerator.

In one embodiment of the invention, the chamber part, the entrance part and the manipulating part are made of flexible material.

In one embodiment of the invention, the chamber part, the entrance part and the manipulating part are made of the same flexible material.

The flexible material is advantageously transparent.

In one embodiment of the invention, the chamber part and the entrance part are made from one or two thin sheets.

In one embodiment of the invention, the manipulating part is made from one or two thin sheets.

In one embodiment of the invention, the sheet(s) are attached along their edges by adhesive bonding or heat sealing, or advantageously by high-frequency welding.

The manipulating part is advantageously attached to an edge of the chamber part.

The closing means advantageously comprises means of attaching the entrance part to itself in a folded or rolled position.

In one embodiment of the invention, the said attachment means comprise self-fastening strips.

A clearer understanding of the invention will be gained from reading the detailed description of certain embodiments taken by way of examples which are in no way limiting and are illustrated in the accompanying drawings:

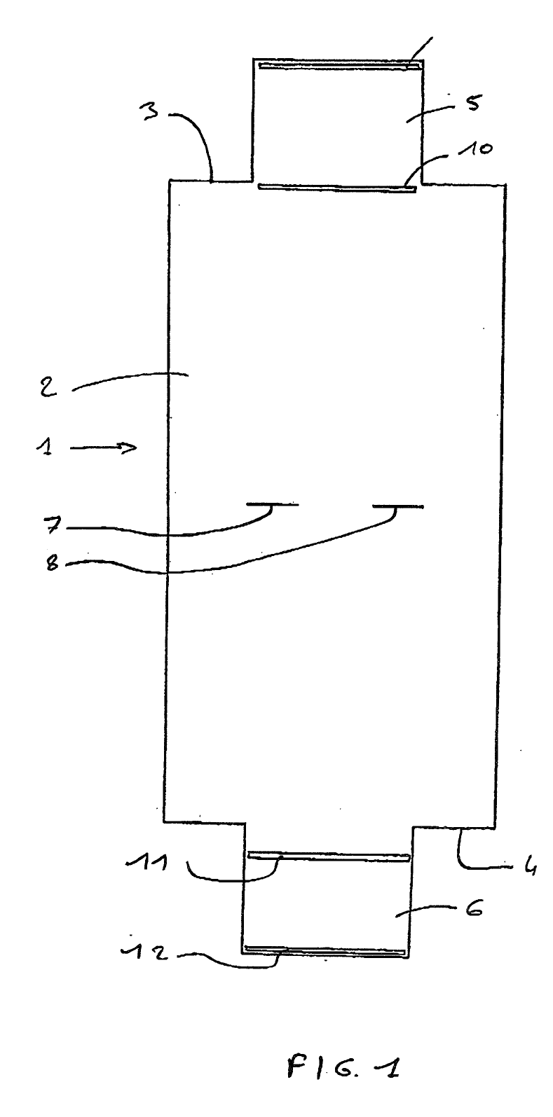

FIG. 1 is a diagrammatic view of a sheet intended to form a device according to the invention;

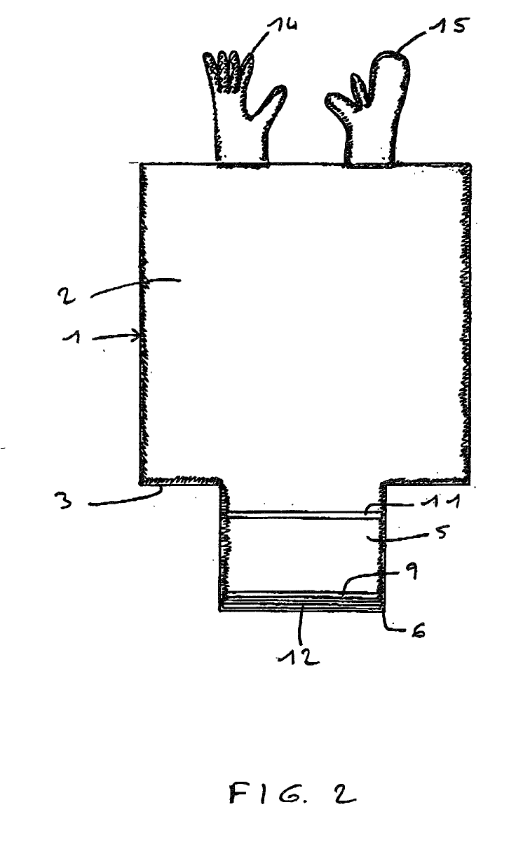

FIG. 2 is a diagrammatic plan view of a device according to the invention; and

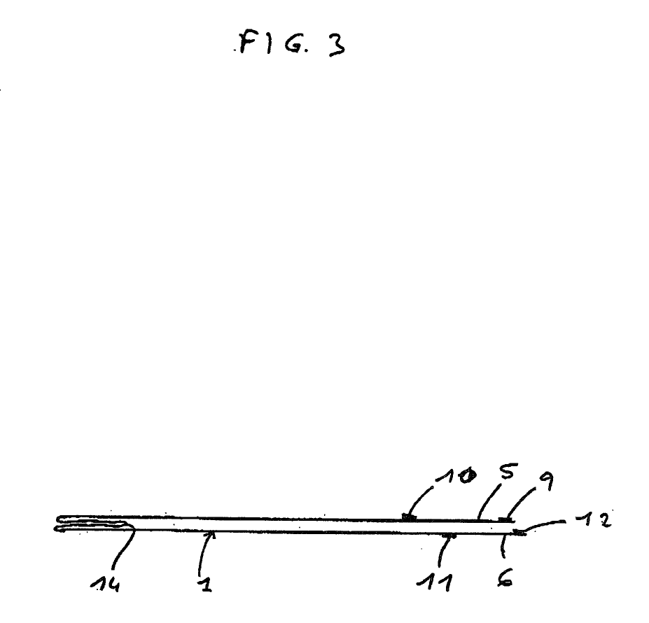

FIG. 3 is a cross section through a device according to the invention.

As can be seen in FIG. 1, a sheet 1 of flexible, leaktight and highly transparent material, advantageously polyurethane, possesses a thickness of between 0.2 and 0.6 mm, preferably between 0.3 and 0.5 mm, especially 0.4 mm. The polyurethane is resistant to abrasion, to a large number of chemicals (methanol, ethanol, ammonia, kerosene, 20% sulphuric acid, etc.) and to microbes.

The sheet 1 is cut in such a way that it comprises a main rectangle 2 with short sides 3 and 4, and end rectangles 5 and 6 adjacent to sides 3 and 4, respectively. The end rectangles 5 and 6 extend lengthwise along part of the sides 3 and 4. For example, the main rectangle 2 may be 160×80 cm and the end rectangles 5 and 6 may be 40×30 cm. In addition, two slits 7 and 8 are formed in the main rectangle 2. The slits 7 and 8 are in line with each other and also parallel to and equidistant from the short sides 3 and 4. The slits 7 and 8 are positioned at a distance from the long sides of the main rectangle 2 and at a distance from each other. The sheet 1 has symmetry about two perpendicular axes lying in its plane, a longitudinal axis and a transverse axis. However, an end rectangle 6 preferably slightly wider than the end rectangle 5, by about an extra 3 cm, will be provided.

Additionally, four fastening strips 9 to 12 are attached leaktightly to the sheet 1. The fastening strips 9 to 12 may be of the reusable adhesive type, in the manner of a Post-it®, or the sort that use small hook parts of the Velcro® variety.

The fastening strip 9 is placed on the end rectangle 5 along its free longitudinal edge furthest from the main rectangle 2. The fastening strip 10 is placed on the main rectangle 2 along its short side 3, along that part of the said short side 3 which is alongside the end rectangle 5. The fastening strip 11 is placed on the end rectangle 6 at a certain distance, e.g. 5 to 15 cm, from that longitudinal edge of the end rectangle 6 which it shares with the short side 4 of the main rectangle 2. The fastening strip 12 is placed on the end rectangle 6 along its free longitudinal edge furthest from the main rectangle 2.

The fastening strips 9 to 12 are placed parallel to each other, with their centres on the longitudinal axis of the sheet 1, and are identical, with a length of for example about 36 cm and a width of about 2.5 cm. The fastening strips 9 to 12 are bonded by an adhesive or heat-sealed or, advantageously, high-frequency welded to the sheet 1.

The strip 10 is attached to that face of the sheet 1 which is visible in FIG. 1 and the strips 9, 11 and 12 are attached to the other face, so that after folding, the strips 9, 11 and 12 are on an external surface of the device 13. The strip 10 is positioned after folding on an external surface of the device 13 because the end rectangle 6 projects outwards past the end rectangle 5.

FIGS. 2 and 3 illustrate the device 13 in the finished condition, which comprises, besides the sheet 1 and the strips 9 to 12, two gloves 14 and 15. The gloves 14 and 15 have been illustrated differently to show two possible embodiments. In FIG. 3, the distance between the two superimposed parts of the sheet 1 has been exaggerated in order to make the drawing clearer.

In practice, the gloves 14 and 15 of a protection device will be identical. Each glove 14, 15 comprises two sheets of material similar to the sheet 1 but from 0 to 0.3 mm thinner than the sheet 1. For example, the thickness of the gloves will be 0.3 mm. To form a glove, two identical sheet portions are cut out, then laid on top of each other and attached in a leaktight manner along their superimposed edges by adhesive bonding, heat sealing, or preferably high-frequency welding to a width of about 2 to 5 mm, except for one edge which is left open so that an operator can insert his or her hand. The glove 14 is shown with five fingers. The glove 15 is shown with three fingers, one being for the thumb and one for the index finger.

After two gloves have been made, they are attached to a sheet 1, the open edge of a glove being applied and then attached in a leaktight manner to the edge of an opening 7 or 8. The method of attachment is as described above. Next, the strips 9 to 12 are attached. The sheet 1 is then folded into two on itself along a fold line 16 parallel to and equidistant from the short sides 3 and 4, and the superimposed edges of the two halves of the sheet 1 are attached in a leaktight manner, as described above, except for the superimposed free longitudinal edges of the end rectangles 5 and 6. In this way each longitudinal half-edge of the main rectangle 2 is attached to the other longitudinal half-edge, and each free portion of a short side 3 is attached to the free portion of the short side 4. “Free portion of a short side” here denotes the portion not adjacent to an end rectangle. Each short side of the end rectangle 5 is attached to the corresponding short side of the end rectangle 6. The edges attached in this way are shown in grey.

Closure is effected by folding the strip 12 180° over onto the strip 9, the end rectangle 6 being slightly longer than the end rectangle 5. The strips 9 and 12 are then rolled approximately three turns about a rolling axis parallel to the length of the strips towards the main rectangle 2, The strip 11 being positioned so as to come into contact with the strip 10 in the course of this rolling process. The end rectangles 5 and 6 are very slightly self-adhesive to each other, which ensures an excellent seal.

The result is thus a device comprising a chamber formed by the main rectangle 2, an entrance to the chamber formed by the end rectangles 5 and 6, manipulating means formed by the gloves 14 and 15 and closing means formed by the strips 9 to 12. In FIG. 2, the gloves 14, 15 have been drawn as if extended out of the chamber, for reasons of clarity. In use, the gloves 14, 15 will be extended into the chamber, see FIG. 3.

The device 1 can be used as follows. With the entrance open, a tool and a suspect object are placed inside the chamber through the entrance. The entrance is closed, leaving a certain amount of air inside the chamber. The hands are placed in the gloves 14, 15. The tool is used to open the suspect object. The suspect object is inspected visually or by means of a suitable apparatus either on the outside or inserted beforehand into the chamber. If, following inspection, the object is still suspect, the closed device is taken to a laboratory for analysis or an incinerator for destruction. If, following inspection, the object is no longer suspect, the entrance is opened by separating strips 10 and 11, then 9 and 12. The tool may be a paper knife or a motor-driven letter-opener.

1. Device (13) for protection against harmful agents, characterized in that it comprises a part forming a chamber, an entrance part to allow an object to be placed in the chamber, a manipulating part (14) for manipulating, from the outside, an object situated inside the chamber, the said parts being made of impermeable walls, and a means of closing the entrance part.

2. Device according to claim 1, characterized in that the chamber part, the entrance part and the manipulating part are made of flexible material.

3. Device according to claim 1 or 2, characterized in that the chamber part, the entrance part and the manipulating part are made of the same flexible material.

4. Device according to claim 2 or 3, characterized in that the flexible material is transparent.

5. Device according to any one of the previous claims, characterized in that the chamber part and the entrance part are made from one or two thin sheets (1).

6. Device according to any one of the previous claims, characterized in that the manipulating part is made from one or two thin sheets.

7. Device according to claim 5 or 6, characterized in that the sheet(s) are attached along their edges by adhesive bonding or heat sealing.

8. Device according to any one of the previous claims, characterized in that the manipulating part (14) is attached to an edge of the chamber part.

9. Device according to any one of the previous claims, characterized in that the closing means comprises means of attaching the entrance part to itself in a folded or rolled position.

10. Device according to claim 9, characterized in that the said attachment means comprise self-fastening strips (9 to 12).
